(19) United States
(12) Patent Application Publication
(10) Pub. No.: US 2025/0132082 A1
(43) Pub. Date: Apr. 24, 2025

(54) PROPULSION SYSTEM USING FORCE FIELD GENERATING COILS

(71) Applicant: Alexandre TIAGO BAPTISTA DE ALVES MARTINS, Brasília (BR)

(72) Inventor: Alexandre TIAGO BAPTISTA DE ALVES MARTINS, Brasília (BR)

(21) Appl. No.: 18/725,944

(22) PCT Filed: Nov. 9, 2022
(86) PCT No.: PCT/BR2022/050429

§ 371 Date: Jul. 1, 2024

(30) Foreign Application Priority Data
Jan. 10, 2022 (BR) 1020220004609

(51) Int. Cl. H01F 7/20; B64G 1/40

(52) U.S. Cl. CPC H01F 7/202; B64G 1/417

(57) ABSTRACT

The present invention relates to a new form of air, land, underwater, or space propulsion, achieved by the use of suitable electromagnetic interactions. When using coils (1), with internal core (2) and support piece (3), subjected to current pulses with asymmetric current derivative and magnetic field, we obtain directional propulsion forces. This is possible due to a new electromagnetic propulsion mechanism that uses the conservation of total momentum where the sum of the mechanical moment with the moment of the magnetic field must always be conserved, resulting in a constant and null total sum of the two components, where the variation of the magnetic field moment will generate a corresponding change in the mechanical moment of the coil, thus generating propulsion forces. When magnetic fields with asymmetric derivative are produced in an external volume, they may also generate force fields.

The present invention relates to a new form of air, land, underwater, or space propulsion, achieved by the use of suitable electromagnetic interactions which will be explained below.

Recent experiments with electromagnetic coils have shown the existence of a new type of propulsion. This is possible due to the conservation of the total momentum where the sum of the mechanical momentum with the magnetic field momentum must always be conserved, resulting in a constant and null total sum of the two components, where the variation in the magnetic field momentum will generate a corresponding change in the mechanical momentum of the coil thus generating propulsion forces.

When the atoms of a magnetic material are subjected to an external magnetic field, they acquire a potential magnetic energy density Uₚₘ given by:

$${U}_{pm} = - M \cdot B = - {μ}_{0} M \cdot ( H + M ) = - {μ}_{0} M \cdot H - {μ}_{0} M \cdot M [ J / {m}^{3} ] \qquad ( 1 )$$

Where B and H are respectively the magnetic field density and the applied magnetic field, μ₀ is the vacuum permeability and M is the atomic magnetization vector given by:

$$M = {χ}_{m} H = ( {μ}_{r} - 1 ) H \qquad ( 2 )$$

With susceptibility χₘ and relative magnetic permeability μᵣ. The magnetic energy density U_{M}, considering the polarization effects of matter by the external application of magnetic fields is:

$${U}_{M} = \frac{B \cdot H}{2} [ \frac{J}{{m}^{3}} ] \qquad ( 3 )$$

Which can be rewritten as:

$${U}_{M} = \frac{( {μ}_{0} H + {μ}_{0} M ) \cdot H}{2} = \frac{1}{2} [ {μ}_{0} H \cdot H + {μ}_{0} M \cdot H ] [ \frac{J}{{m}^{3}} ] \qquad ( 4 )$$

This equation represents the sum of the magnetic energy densities in the vacuum and inside matter. The temporal variation of the energy density ∂U_{M}/∂t will be:

$$\frac{\partial {U}_{M}}{\partial t} = \frac{1}{2} \frac{\partial }{\partial t} [ {μ}_{0} H \cdot H + {μ}_{0} M \cdot H ] = {μ}_{0} H \cdot \frac{\partial H}{\partial t} + {μ}_{0} H \cdot \frac{\partial M}{\partial t} [ \frac{J}{{m}^{3}} \frac{1}{s} ] \qquad ( 5 )$$

The relationship between the linear momentum p_{fields} and the energy u_{fields} for electromagnetic fields is given by:

$${p}_{fields} = \frac{{u}_{fields}}{c} [ kg \cdot m \cdot {s}^{- 1} ] \qquad ( 6 )$$

Where c is the speed of propagation of electromagnetic fields or waves, associated with the speed of light. The last equation for the linear momentum of electromagnetic fields uses the equivalence between energy and matter initially established by Einstein. The total conservation of momentum between fields (p_{fields}) and matter (pₘₐₜₜₑᵣ) requires that:

$${p}_{matter} + {p}_{fields} = 0 {p}_{matter} = - {p}_{fields} = - \frac{1}{c} {u}_{fields} [ kg \cdot m \cdot {s}^{- 1} ] \qquad ( 7 )$$

According to Newton's laws, force is proportional to the temporal variation of linear momentum, providing the following equation for force density:

$${f}_{matter} = \frac{d {P}_{matter}}{dt} = - \frac{d {P}_{fields}}{dt} = - \frac{1}{c} \frac{d {U}_{fields}}{dt} [ \frac{N}{{m}^{3}} ] \qquad ( 8 )$$

Where fₘₐₜₜₑᵣ is the force density developed in matter, Pₘₐₜₜₑᵣ is the linear momentum density of matter, P_{fields} is the linear momentum density of fields, and U_{fields} is the energy density of fields. We take the approximation of considering the speed of light constant. Equation (8) represents the total balance between force densities that must exist due to the conservation of the total linear momentum between the considered matter and fields, that is:

$$\frac{d {P}_{matter}}{dt} + \frac{d {P}_{fields}}{dt} = 0 [ \frac{N}{{m}^{3}} ] ⇒ \frac{d {P}_{matter}}{dt} + \frac{1}{c} \frac{d {U}_{fields}}{dt} = 0 [ \frac{N}{{m}^{3}} ] \qquad ( 9 )$$

For magnetic fields applied in coils, using Equations (1) and (4), the magnetic field linear moment density P_{M} in the coil can be written as:

$${P}_{M} = \frac{{U}_{M}}{c} = - \frac{B \cdot H}{2 c} = - \frac{1}{2 c} [ {μ}_{0} H \cdot H + {μ}_{0} M \cdot H ] \qquad ( 10 )$$

Where we use the definition of magnetic interaction potential energy which is negative for magnetic materials subjected to magnetic fields, as shown in Equation (1). This negative moment means that the linear momentum of magnetic fields is directed in the opposite direction to the applied magnetic field vector, as also confirmed by experimental observations. From Equations (8) and (10), the magnetic force of displacement in matter becomes:

$${f}_{matter} = \frac{d {P}_{matter}}{dt} = - \frac{d {P}_{M}}{dt} = \frac{μ 0}{c} H \cdot \frac{\partial H}{\partial t} + \frac{μ 0}{c} M \cdot \frac{\partial H}{\partial t} [ \frac{N}{{m}^{3}} ] \qquad ( 11 )$$

This equation consists of two terms, where the first term reflects the use of coils where the core is air or vacuum with relative magnetic permeability of one, and the second term reflects the use of magnetic materials with relative magnetic permeability different from one inside the coil.

The total force F_{Total} developed in the coil with a core of volume V_{core} will be directly proportional to the rate of pulses per second γₚᵤₗₛₑ:

$${F}_{Total} = {γ}_{pulse} {V}_{core} \sqrt{{ε}_{r} {μ}_{r}} ( \frac{μ 0}{c} H \cdot \frac{\partial H}{\partial t} + \frac{μ 0}{c} M \cdot \frac{\partial H}{\partial t} ) [ N ] \qquad ( 12 )$$

Where we add the term \sqrt{εᵣμᵣ} due to the change in the speed of light inside the core. Equation (12) also includes forces related to the variation in magnetization M (Equation (2)) of the magnetic material used in core 2, that is, it includes variations over time of two different variables: both the magnetic field H and the relative magnetic permeability μᵣ. Due to the inner product used in Equation (12), we can also write that:

$$\frac{μ 0}{c} M \cdot \frac{\partial H}{\partial t} = \frac{μ 0}{c} H \cdot \frac{\partial M}{\partial t} = \frac{μ 0}{c} H \cdot \frac{\partial [ ( {μ}_{r} - 1 ) H ]}{\partial t} .$$

Therefore, in the final calculation of the force in Equation (12), we will have to consider the effects of temporal change of both the magnetic field H and the relative magnetic permeability μᵣ. In this way, the advantages of using magnetic materials for core 2 where the relative magnetic permeability varies over time in synchrony with the applied magnetic field (nonlinear magnetic materials) becomes clear.

If a single asymmetric current pulse generates a force of 1 N, then if we apply a rate of 1000 pulses per second, the total force generated will be 1000 N. In this way we can generate small or giant forces using the same physical system with a coil or coil system.

The second term of Equation (12) represents the temporal version of the Kelvin spatial magnetic gradient force equation f_{KM}, given by:

f_{KM}=μ₀(M·∀V)H[N/m³] (13)

Where magnetic materials are attracted in the direction of the gradient of the applied external magnetic fields. When using the equation for the propagation of magnetic fields in space:

$${∇}^{2} H = {ε}_{0} {μ}_{0} \frac{{\partial }^{2} H}{\partial {t}^{2}} = \frac{1}{{c}^{2}} \frac{{\partial }^{2} H}{\partial {t}^{2}} \qquad ( 14 )$$

And if we take the square root of this last equation, we obtain:

$$∇ H = \frac{1}{c} \frac{\partial H}{\partial t} \qquad ( 15 )$$

Which gives us the spatial gradient of the magnetic field in terms of the temporal variation of the field and its speed. By substituting Equation (15) into Equation (13), we recover a simplified version of the magnetic displacement force density f_{DM}, as given by the second term of Equation (12):

$${f}_{DM} = \frac{μ 0}{c} M \cdot \frac{\partial H}{\partial t} [ N / {m}^{3} ] \qquad ( 16 )$$

This equation is simply a temporal variation (never before developed in these terms) of a long-known equation, where forces are developed in magnetic materials due to the spatial gradient of the magnetic field generated in our case by the temporal variation of magnetic fields. This result is yet another confirmation of the moment associated with the magnetic field in the opposite direction to the magnetic vector, confirming our initial derivation, Equation (12), in terms of conservation of field energy and total conservation of the sum of mechanical and field momentum. Using simple calculations, it is easy to demonstrate that Equation (12) can be rewritten in terms of the current I passing through a coil with inductance L as:

$${F}_{Total} = {γ}_{pulse} \sqrt{{ε}_{r} {μ}_{r}} \frac{LI}{c} \frac{\partial I}{\partial t} [ N ] \qquad ( 17 )$$

If the derivative of the magnetic field or the initial and final current are symmetrical, then no force will be generated. Equations (12) and (17) only develop directional forces when the derivatives of the magnetic field and current are asymmetric. These two equations are unique because they are directly proportional to H·∂H/∂t and I∂I/∂t, not requiring time integration as done for Lorentz forces and others that are initially formulated in steady state.

A great advantage of the magnetic displacement force is that the shorter the applied pulse, the stronger the force generated, due to the fact that it is a time-dependent force where the momentary gradient of the magnetic field propagated in the magnetic material increases with pulse speed. In this way, the propagation of a single current pulse or longitudinal magnetic field will directly generate the force given by Equations (12) and (17).

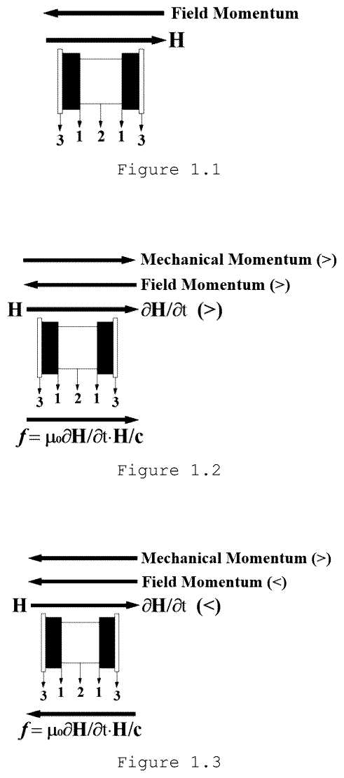

Considering a magnetic coil 1 without solid core 2 and with support piece 3, initially with zero mechanical momentum and field, and if we apply an electric current to the coil, then it will gain an electromagnetic momentum in the opposite direction to the magnetic field vector H (FIG. 1.1). If the applied current increases, the magnetic field also increases, increasing the linear field momentum in the process and generating a mechanical linear momentum opposite to the applied linear momentum as required by conservation of total momentum, so that the total sum of the momentum and its variation are zero, where the mechanical force generated is proportional to the temporal variation of the magnetic field momentum as the current increases (FIG. 1.2). If the current applied to coil 1 now decreases or collapses, then the field momentum will disappear leading to the generation of mechanical momentum in the same direction as the collapsing field momentum, as required by conservation of total momentum (FIG. 1.3). All mechanical forces generated will be proportional to the temporal variation of the magnetic field momentum.

If we now add a core 2 to coil 1 of non-conducting material (to avoid losses due to induction currents or Eddy currents at high frequencies) made of hard magnetic material, such as a permanent magnet with fixed magnetization vector M aligned with the applied external magnetic field, then the magnetic linear momentum and force generated will be amplified due to the relative magnetic permeability of the material used according to Equations (11), (12), and (17). It will also be advantageous to use non-conductive and non-linear soft magnetic materials, such as ferromagnetic or ferrimagnetic cores, but in this case their analysis becomes more complex due to non-linear changes in the relative magnetic permeability of the core according to known hysteresis curves. In this case, the extra variation in the magnetization vector will also contribute to the observed force, as we saw previously.

By the correct use of current pulses with asymmetric derivative applied to coil 1, we are able to generate directional forces in any of the two longitudinal directions collinear with coil 1 and the flux lines/magnetic field, whose magnitude increases with the speed of the applied pulse and pulse frequency. The theory developed here is valid for any type of coil 1, including symmetric or asymmetric coils.

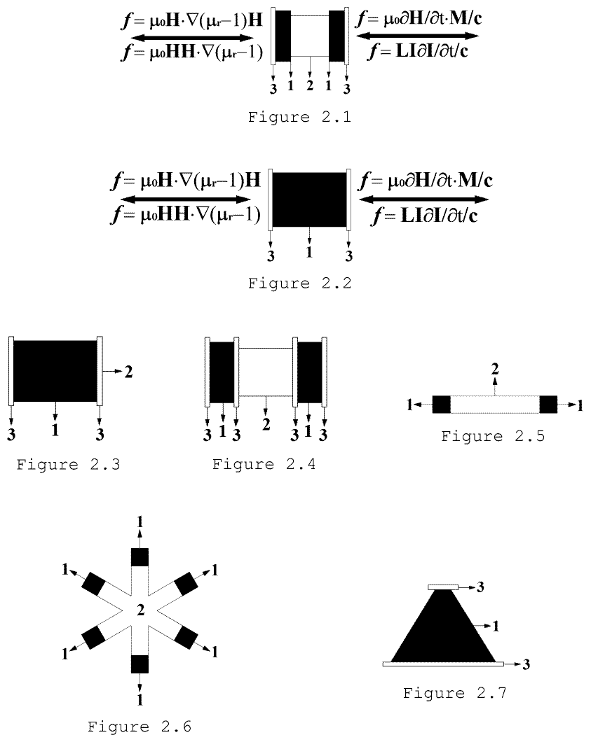

As we can see (FIGS. 1.2 and 1.3 and FIGS. 2.1 and 2.2) coil 1 will move in the direction necessary to satisfy total momentum conservation of the space-time around it. Any acceleration generated by mechanical forces will feel forces of inertia, due to the relative movement of space-time opposite to the acceleration of the object, and where the momentum and temporal variation of the momentum of the involved mass and space-time must cancel each other according to Equations (7) and (9). As the force in the propulsion system of this patent is generated by direct interaction with space-time, where the magnetic field momentum also corresponds to space-time momentum, then the generated forces will be produced without inertia, that is, without resistance from space-time. The same process happens for bodies accelerated by gravitational forces that directly modify space-time, which according to Einstein's theory of Relativity will not feel any force of inertia when accelerated by a gravitational field.

In this propulsion system, teleportation will be generated when I∂I/∂t, or B·∂B/∂t, or H·∂H/∂t, exceed a certain threshold value. The phenomenon occurs because the magnetic field B has a linear momentum given by Equation (10), where the variation of the magnetic field and its linear momentum will be proportional to the rotational speed of space-time, that is, proportional to the rotational speed of the electric field E(∀×E=−∂B/∂t). Regardless of the direction of the space-time velocity in relation to the magnetic field vector B, we can observe that ∂B/∂t represents a rotational acceleration of space-time, which behaves like a superfluid as explained in Einstein's theory of Relativity. As is known in fluid dynamics, under the name of supercavitation, when a fluid is accelerated above a certain limiting speed, then a phase change will occur in the fluid from the liquid to the gaseous phase, for example, dramatically decreasing the density of the fluid itself and consequently dramatically increasing the speed of propagation allowed through it.

In this way, applying a single pulse of extremely high magnitude I∂I/∂t, or B·∂B/∂t, or H·∂H/∂t, above a given transition value, teleportation will be generated in the same direction as the “spatial warp” force, Equations (11), (12) and (17), where the distance covered in a single teleportation “jump” will depend on the total magnitude of the used pulse. To generate teleportation and the displacement of masses without inertia, it is necessary to generate magnetic fields distributed partially or completely around the total mass to be transported.

Using Equation (2), Equation (13) can also be written as:

$${f}_{KM} = {μ}_{0} ( M \cdot ∇ ) H = {μ}_{0} ( H \cdot ∇ ) M = {μ}_{0} H \cdot ∇ ( {μ}_{r} - 1 ) H \qquad ( 18 )$$

Therefore, when we pulse magnetic fields, the force generated will be proportional to the spatial (or temporal) gradient of the magnetic fields, but also proportional to the gradient of the relative magnetic permeability μᵣ of the magnetic material 2 that constitutes the core of the coil 3. When the applied current is constant and the magnetic field is symmetrical, then the force generated will be given by:

$${f}_{KM} = {μ}_{0} H \cdot ∇ ( {μ}_{r} - 1 ) H = {μ}_{0} {H}^{2} \cdot ( ∇ {μ}_{r} - 1 ) \qquad ( 19 )$$

In other words, the force will be proportional to the spatial gradient of the relative magnetic permeability μᵣ of the magnetic material used in core 2 of the coil. This is another way of using coils 1 for propulsion using the application of constant, oscillating or pulsed currents and magnetic fields (FIGS. 2.1 and 2.2), in symmetrical or asymmetrical (conical) coils 1. Core 2 may be made of one or more materials, individually uniform or non-uniform, placed or used in such a way that they generate a gradient of relative magnetic permeability μᵣ along core 2, internal or external to coil 1, or along the interior of coil 1, in a given direction. An example of application could be the use of a uniform core 2 placed inside coil 1 from its end to its center or close to it, that is, placed asymmetrically inside coil 1 but mechanically attached to it, with the rest of core 2 from coil 1 being the air or vacuum itself. Or we can use a core 2, in a single piece, with asymmetric magnetic properties, inside coil 1, among many other possibilities.

Although our preferred application uses asymmetrically pulsed magnetic currents and fields with uniform cores, the application of non-uniform magnetic cores may increase the force generated if the relative magnetic permeability gradient μᵣ of the magnetic material used generates a force in the same direction as the asymmetric pulses applied (FIGS. 2.1 and 2.2).

The present invention will now be described in detail, without limitation and by way of example, using preferred embodiments, represented in the attached drawings, in which:

FIG. 1 describes the theory of the “spatial warp” force or magnetic displacement/magnetization force acting on the coils, due to the total conservation of linear momentum.

FIG. 2 represents various forms of application of propulsion systems using coils with linear external and internal cores and compositions thereof.

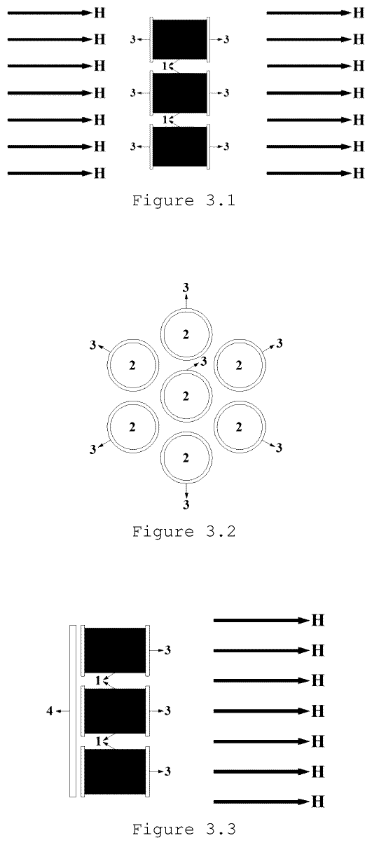

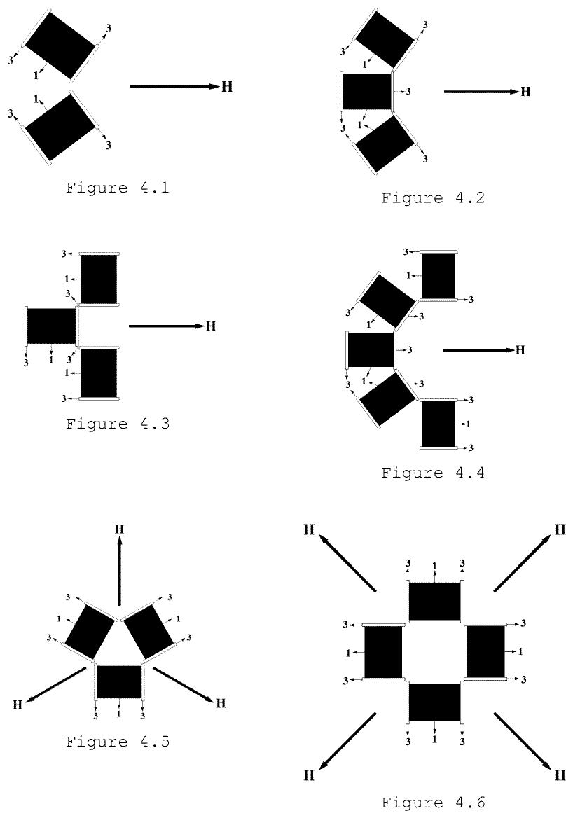

FIG. 3 represents various ways of applying propulsion units using groups of parallel coils.

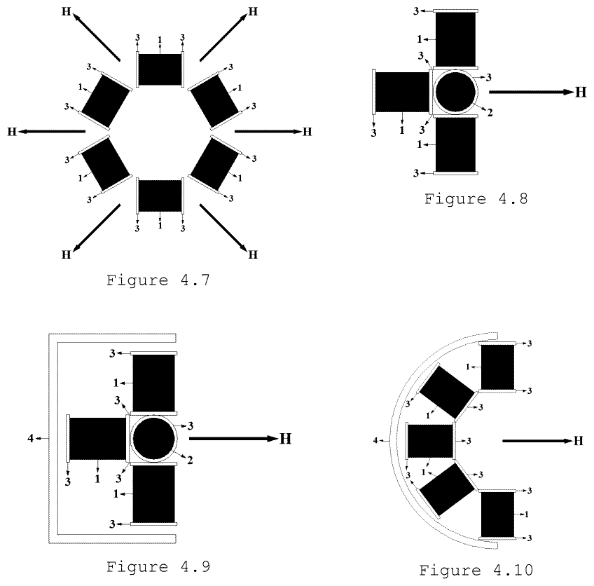

FIG. 4 represents various ways of applying propulsion units using groups of coils forming an angle to each other.

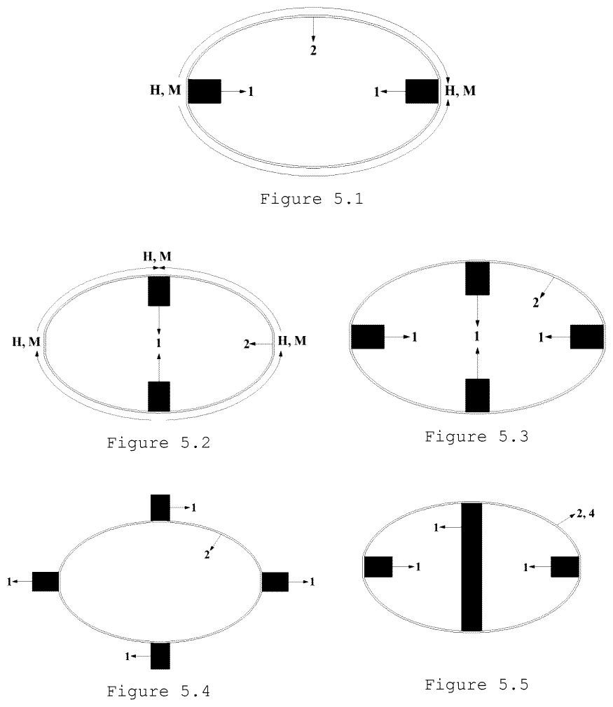

FIG. 5 represents various application forms of propulsion units using coils with oval outer cores and linear inner cores.

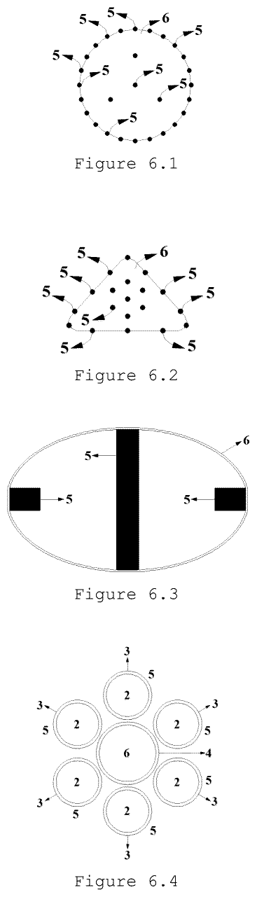

FIG. 6 represents various ways of applying propulsion units to structures with different geometries.

### DESCRIPTION OF THE PREFERRED EMBODIMENT

With reference to the figures, the preferred embodiment of the invention will now be described. In the attached figures, equal numbers correspond to equivalent components in different configurations.

Each of the configurations that we will describe results from a natural development of the previous one, using the same physical principles to generate the propulsion forces described previously, being natural and different variations that complete and complement each other. This patent considers configurations that use isolated or in group coils 1, with internal and/or external cores 2, which can be placed in any arrangement.

Our favorite configuration consists of a coil 1 with inner core 2 and coil support piece 3. The inner core 2 of coil 1 may be pure and uniform, or be a symmetric or asymmetric mixture of one or more different magnetic and/or dielectric materials, which may be constituted by air or vacuum itself (FIGS. 1.1 to 1.3), or by any magnetic material (FIGS. 2.1 to 2.3) with positive or negative relative magnetic permeability, linear or non-linear, such as permanent magnets, or conductive or non-conductive ferromagnetic or ferrimagnetic cores, or ferrofluids, among other possibilities, that is, any combination of magnetic materials in the solid, and/or liquid, and/or gaseous state, which can be conductive or non-conductive, and with any type of particle or nano-particle in suspension, conductive, non-conductive, semi-conductive, magnetic or any other.

From Equations (12) and (17) we can observe that the value of the relative dielectric constant of the material that makes up core 2 affects the force generated, so it will be advantageous to also use a core 2 made of any dielectric material that can be made up of any material solid, liquid or gaseous, which may have a positive or negative permittivity, be linear or non-linear, which will influence the direction of the force generated and its magnitude, or even be the vacuum itself or a gas at low or high pressure. This dielectric may be pure or a symmetric or asymmetric mixture of several different dielectrics and may optionally contain embedded within it any number of small conductive, semiconductor, or non-conductive particles of positive or negative permittivity or permeability, linear or not linear, such as metallic powder or paint, or magnetic, or semiconductor.

The support part 3 of coil 1 serves the purpose of providing mechanical structure to coil 1, and may be made of any material, including for example, dielectric non-conductive materials or non-magnetic conductive materials. Part 3 can keep coil core 2 open (FIGS. 1.1 to 1.3) or on the contrary, part 3 can contain and completely enclose core 2 of coil 1 (FIGS. 2.1 and 2.2). Core 2 may also perform functions related to part 3.

Coil 1 and its core 2 may assume any geometry and three-dimensional shape with any cross-section, including circular, ellipsoidal, square, triangular or any other cross-sections, hollow or solid. Coil 1 may be long and with the same length as core 2 as in FIGS. 1.1 to 2.3, where the interruption of coil 1 in some of these figures only serves the purpose of correctly visualizing the internal core 2 of the coil. Or coil 1 may have a different size than core 2, which may be larger or smaller than coil 1.

We can also use one, two or more coils 1 (FIG. 2.4) around a single core 2, which connects the coils 1 to each other directly. Core 2, internal or external, may assume any solid or hollow three-dimensional shape, such as a cylinder (hollow or not) between the two coils (FIG. 2.4). Coils 1 may be around the external core 2 that connects them together, at the ends (FIG. 2.4) or in any other position, or coils 1 may have their own independent and separate core 2, being placed at the ends of the external core 2 (FIG. 2.5). This configuration allows forces to be generated in two opposite directions along the longitudinal axis of core 2.

In order to generate forces in several different directions using this approach, we can use a cross-shaped outer core 2 (vertical and horizontal directions perpendicular to each other) with one or more coils 1 at each end, or a star-shaped outer core 2 with six tips or ends, and one or more coils 1 at each end (FIG. 2.6). Where the outer core 2 may have any number of radial ends, always with one or more coils 1 at each end, or in any other position around the core 2. In this way, when choosing which coil 1 or pair of coils 1 is electrically driven, we can easily choose the vector direction of the generated force. All coils 1 may be linear and symmetrical as seen so far, or they may also be asymmetrical or conical (FIG. 2.7).

We can also use coils 1 close together and arranged parallel to each other, to generate a strong external magnetic field, in a large external volume, at both ends of the coils 1 (FIG. 3.1). These coils can be arranged together in any geometric configuration, including a circular or hexagonal configuration with or without coils inside (FIG. 3.2), or square, ellipsoidal or any other configurations.

Coils 1 can be surrounded and protected, individually at one of their ends, or on one or more faces of groups of coils 1, in a partial and asymmetrical way (FIG. 3.3) by any mixture of dielectric and/or conductive, and/or magnetic material 4, with the purpose of generating additional forces or containing in space an asymmetric part of the electromagnetic fields generated by coils 1. Eventually, this material 4 may completely and symmetrically surround coil 1 or groups of coils 1 used.

Let us now consider the use of groups of coils in specific geometric configurations with each other and with improved performance due to proximity effects between coils with the generation of large volume magnetic fields in the space outside the coils. Let us consider a configuration using two similar coils 1, each one using or not an internal core 2, arranged to each other at an angle such that one of their ends approaches and the opposite end moves away at the same time, both electrically excited to generate a magnetic field H internal and external in the same vectorial direction. This configuration (FIG. 4.1) will generate a magnetic field H external to coils 1 of large volume in the space around them with a direction equivalent to the vector sum of the magnetic field H external to the two coils 1. This configuration will be more efficient than using only isolated coils 1, because in addition to generating strong magnetic fields internal to the coil itself, they additionally generate strong directional magnetic fields in a large volume external to coils 1, located where the magnetic fields of the two coils 1 repel each other with greater intensity, that is, in the zone external to the two closest ends of coils 1.

We can use any number of coils 1 in close proximity to each other, forming any global geometry and arranged at an angle placing one of their ends closest (FIGS. 4.1 to 4.4). We can place, for example, three coils 1 in close proximity to a horizontal central coil 1 and the other three external coils 1 at an angle less than 90° with the central coil 1 (FIG. 4.2). In the limiting case, the outer coils 1 can assume an angle of 90° with the central coil 1 (FIG. 4.3), and we can use any number of coils 1 in lateral proximity and mutual magnetic repulsion, along a hemispherical section or half of a sphere, with a two-dimensional section in the shape of a “C” or “U”, for example (FIG. 4.4).

Other variations include various geometric arrangements using three (FIG. 4.5), four (FIG. 4.6), six (FIG. 4.7) or more coils 1, with their respective ends in lateral proximity to each other, forming various geometric patterns such as triangular patterns (FIG. 4.5), quadrangular (FIG. 4.6), hexagonal (FIG. 4.7), or any other geometric pattern, dependent on the total number of coils 1 used.

While in the configurations shown in FIGS. 4.1 to 4.4, all coils 1 used are preferably electrically excited at the same time, in the configurations shown in FIGS. 4.5 to 4.7, an isolated or dual excitation, in pair, is preferably applied to two of the coils 1 considered, in order to generate directional propulsion forces along the two longitudinal directions along the internal and external magnetic field H generated, allowing to choose and vary the vectorial direction of the force generated using a single system or group of coils 1 in proximity. Using three coils 1 (FIG. 4.5), we will have three force directions available to choose from, while if we use four coils (FIG. 4.6) we will have four force vector directions available, and with six coils (FIG. 4.7) we correspondingly also have six different vector directions for the forces generated, depending on the electrically excited coils 1 or pairs of coils 1. Note that in several of these configurations we can simultaneously electrically excite geometrically opposite pairs of coils 1 in order to generate a total force of greater magnitude in a given direction.

The geometric shapes presented in FIGS. 4.1 to 4.7 for the distributions and geometric organizations of the various coils 1 among themselves may simply represent planar two-dimensional sections or geometries with a complex three-dimensional structure, including numerous variations. That is, the triangular shape may be planar or three-dimensional pyramid; the quadrangular shape may be planar or a three-dimensional square with six opposing perpendicular open surfaces, with coils 1 arranged along the edges of this 3D square; the hexagonal shape may be planar or a complex three-dimensional structure, with coils 1 arranged along the edges of geodesic structures of the type created by Buckminster Fuller similar to the structure (full, half, or any section) of carbon 60, for example, between so many other possibilities and geometries available.

A final possibility of geometric organization includes the use of three, four, five, six or any number of coils 1 arranged symmetrically with each other in a two-dimensional plane, all oriented towards the same geometric center, in a cross for example, in a symmetrical or asymmetrical pattern, with the magnetic field in opposition from all coils 1 to the geometric center, and arranging a fifth coil 1, or more than one coil (1), perpendicular to that geometric plane and in the center thereof, placed with its magnetic field in repulsion with the remaining coils 1. This configuration (FIG. 4.8) generates an amplified magnetic beam, in front of the single coil 1 perpendicular to the central plane of the other coils 1, which does not have another coil 1 in opposition, and was the subject of a patent to Boyd Bushman (U.S. Pat. No. 5,929,732). In the claims of this patent, Boyd only mentions a sinusoidal excitation of the coils around the magnets, which may not be sufficient to generate propulsion forces according to our model. But if we apply pulsed currents with an asymmetric current derivative, according to Equations (11), (12) or (17), to one or more of the coils 1 around the magnets, then this assembly can develop propulsive forces at the same time along the externally emitted magnetic field beam in volume, depending on whether the unopposed central coil 1 or one or more of the lateral (opposed) coils 1 is actuated, as discussed in relation to FIG. 1, thus allowing vectorial control of the direction of the force generated depending on the coil or coils 1 that are electrically actuated.

All configurations shown in FIGS. 1 to 4 represent propulsion units 5, which can be wrapped and protected, individually at one end of coil 1, or at one or more faces of groups of coils 1, in a partial and asymmetrical way (FIGS. 4.9) and 4.10) by any mixture of dielectric, and/or conductive, and/or magnetic material 4, with the purpose of containing in space an asymmetric part of the electromagnetic fields generated by the propulsion units 5. Eventually, this material 4 may involve completely and symmetrically the coil 1 or groups of coils 1 used. This process prevents electromagnetic emission that could harm the operation of nearby electrical equipment or avoids exposure to such fields of people or biological material near the propulsion units 5 but may be used to absorb or attenuate the magnetic fields generated by the propulsion units 5, in a given direction, and allowing the free emission of these fields in volume to the outside in the area of the propulsion unit 5 without this material (FIGS. 4.9 and 4.10), allowing the generation of directional forces.

Core 2 may also be external, in relation to coil 1, with shapes different from the linear and radial configurations used in FIGS. 2.4 to 2.6 and may assume any three-dimensional shape that may contain an open volume inside (capable of transporting people or load internally, for example), such as a hollow oval shape for example (FIGS. 5.1 to 5.5). By using two coils 1, or groups of coils 1, in opposite geometric positions, connected to each other by an oval external core 2, it will be possible to generate a magnetic field of large size and volume along the entire core 2 in a horizontal direction (FIG. 5.1) or vertical (FIG. 5.2) for propulsion purposes as discussed in relation to FIG. 1. By using coils 1, or groups of coils 1, or pairs of coils 1 in any number and geometric relationship we can generate propulsion forces by choosing which of coils 1 or pairs of coils 1 that are activated to generate magnetic fields and directional propulsive forces (FIGS. 5.3 and 5.4), where coils 1 can be contained, or surrounded by core 2 (FIGS. 5.1 to 5.3) or on the contrary can be placed outside core 2 (FIG. 5.4).

These coils 1 may be small as shown, or they may be long, where one or more opposing pairs of coils 1 may be replaced by a single long coil 1 (FIG. 5.5). The various coils 1 interconnected by an external core 2, larger than the coil itself (FIGS. 5.1 to 5.5), may each have a core 2 internal to the coil itself, which may be solid, liquid, gaseous or even vacuum. as discussed previously.

All configurations shown in FIGS. 1 to 5 represent propulsion units 5, which can be independent or on the contrary be connected to each other in any distribution or grid (FIGS. 6.1 to 6.4). We can also use in all propulsion units 5 any power supply of high or low current or constant current, or oscillating, or pulsed, or any other, including asymmetric pulses, or with an asymmetric current derivative. Examples of non-limiting power supplies include Marx generators, inductive current pulse generators, microwave generators with asymmetric current pulses, among many other options.

The conductive material of coil 1 may be any type of conductor, including any type of superconductor. Coils 1, people, load or any other object may be surrounded and protected, individually or in groups, partially or completely, by any mixture of dielectric, and/or conductive, and/or magnetic material 4, as occurs naturally through use of oval external cores 2 (FIG. 5.5), with the purpose of containing the electromagnetic fields generated by coils 1 in space, in order to avoid electromagnetic emission that could harm the operation of nearby electrical equipment, as well as avoiding exposure to these fields of people or biological material close to coils 1.

This process prevents electromagnetic emission that could impair the operation of nearby electrical equipment, or avoids exposure to such fields of people or biological material near the propulsion units 5, but may be used primarily to generate additional forces or to absorb or attenuate the magnetic fields generated by the propulsion units 5, in a given direction, and allowing the free emission of these fields in volume to the outside in the area of the propulsion unit 5 without this material (FIGS. 3.3, 4.9, and 4.10).

A protective force field may be generated by the propulsion units 5 around a moving or stationary mass 6, by the external magnetic fields present in volume around mass 6, where any object that approaches mass 6 will be strongly repelled, with total strength given by Equation (12) where V_{core} will in this case be the volume of the external object considered. Any small asymmetry in the force fields will allow the movement of mass 6 in a given direction with full protection by the generated force fields. Applications of the force fields generated in this way are numerous and include the movement of ships in space, in the atmosphere or in water, in a completely protected manner and free from collisions with masses. As an example of the application of the generated force fields, we have the repulsion, attraction or deflection of space debris or asteroids. Another application will be the extinguishing of forest fires or any type of fire simply using the repulsion forces generated by the force fields by the approach of an aerial ship that uses a propulsion system like the one reported in this patent, which generates force fields at a distance and with large volume.

In order to illustrate some preferred and non-limiting applications of the propulsion units 5 discussed previously we now illustrate some concepts in FIG. 6. We can use a uniform distribution of propulsion units 5 around the periphery of a mass 6, to control the direction of horizontal or vertical propulsion forces (FIGS. 6.1 to 6.4). In these cases, we may, for example, use several propulsion units 5 distributed in triangular (FIG. 6.1), or hexagonal (FIG. 6.2), or circular (FIGS. 6.1 and 6.2) patterns along the upper, lower, or lateral surfaces. Any uniform or non-uniform pattern in the distribution of propulsion units 5 may be used. Instead of using some propulsion units at specific points of mass 6 or ship 6 that we want to move, we can make the entire ship or mass 6 a gigantic propulsion unit (FIG. 5 and FIGS. 6.3 and 6.4), using any of the 5 propulsion units shown.

As illustrated, any desired shape for the ship or mass 6 can be used (FIG. 6). The only important factor is the use of one or more propulsion units 5 in order to control the direction of propulsion, which can be on the periphery of mass 6 or immersed in any position within it. Other variations to consider will be independent vertical, diagonal or horizontal parts of the ship or mass 6 which may contain propulsion units 5 and be movable and tiltable in any direction. All the variations discussed can be applied to motorbikes, cars, flying skateboards with automatic height control, submarines, planes, ships, drones, flying platforms in any environment, personal transport like “Jet Pack” on the back or motorbikes and flying cars, among many other related and unmentioned application possibilities, including all previous applications regarding the application of force fields, inertialess propulsion and teleportation.

1. Electromagnetic propulsion system, characterized by the use of a coil (1), with internal core (2) and optional support piece (3), where pulses of current I or magnetic field B with asymmetric temporal derivative are applied, i.e. with the asymmetric product I·∂I/∂t or B·∂B/∂t, to one or more coils (1), or one or more propulsion units (5), with any magnitude or pulse repetition rate, including the application of pulses of extreme magnitude.

2. Electromagnetic propulsion system, according to claim 1, characterized by the use of a core (2) internal and/or external to the coil (1), where the core (2) can be pure and uniform, or be a symmetrical or asymmetric mixture of one or more different magnetic and/or dielectric materials, which may be constituted by the air or vacuum itself, or by any magnetic material, with positive or negative relative magnetic permeability, linear or non-linear, such as permanent magnets, or ferromagnetic or ferrimagnetic cores, conductors or non-conductors, or ferrofluids, among other possibilities, that is, any combination of magnetic materials in the solid, and/or liquid, and/or gaseous state, which can be conductive or non-conductive, and with any type of particle or nano-particle in suspension, conductive, non-conductive, semi-conductive, magnetic or any other; and/or where the core (2) may be made up of any solid, liquid or gaseous dielectric material, which may have a positive or negative, linear or non-linear permittivity, or even be a gas at low or high pressure, where the dielectric may be pure or be a symmetrical or asymmetrical mixture of several different dielectrics and may optionally contain embedded within it any number of small conductive, or semiconductor, or non-conductive particles of positive or negative permittivity or permeability, linear or non-linear, such as for example metallic, or magnetic, or semiconductor powder or paint.

3. Electromagnetic propulsion system, according to claim 1, characterized by the optional use of one or more support parts (3) of the coil (1) to provide mechanical structure to the coil (1), where the part (3) may be made of any material, including, for example, non-conductive dielectric materials or non-magnetic conductive materials; and where the part (3) can keep the core (2) of the coil open to the outside or on the contrary, the part (3) can contain and completely close the core (2) inside the coil (1); where the core (2) can also perform functions related to the part (3); where the core (2) can be fixed to the coil (1) by any process.

4. Electromagnetic propulsion system, according to claim 1, characterized by the use of the coil (1) with the same length as the core (2), or where the coil (1) may have a different size from the core (2), the which may be larger or smaller than the coil (1); where we can use one, two or more coils (1) around each core (2), which can connect the coils (1) to each other directly; or where the coils (1) may be around the outer core (2) that connects them, at the ends or in any other position; or where the coils (1) may have their own independent and separate core (2), being placed at the ends or in any other position of the external core (2); or where the conductive material of the coil (1) may be any type of conductor, including any type of superconductor.

5. Electromagnetic propulsion system, according to claim 1, characterized by the use of an external cross-shaped core (2), with the vertical and horizontal directions perpendicular to each other and with one or more coils (1) at each end, or by the use of a star-shaped outer core (2) with six points or ends and with one or more coils (1) at each end, where the outer core (2) may have any number of radial elements or ends, always with one or more coils (1) at each end, or in any other position around the core (2).

6. Electromagnetic propulsion system, according to claim 1, characterized by the use of one or more cores (2), internal or external to the coil or coils (1), which may assume any solid or hollow three-dimensional shape, such as a cylinder, hollow or not, inside or outside a coil (1), or between two coils (1) in a direct linear fashion; or where the core (2) may also be external and assume any other three-dimensional shape that may contain an open volume inside, of any dimension, where for example, we may use a core (2) with a hollow, two-dimensional or three-dimensional oval shape, where coils (1), or groups of coils (1), or two or more coils (1) are placed inside them in opposite geometric positions, or in any other arrangement, connected to each other by the external core (2), in a way to generate a magnetic field of large size and volume throughout the core (2) in any direction for propulsion purposes; where the coils (1) or pairs of coils (1) can be in any number and geometric relationship; where coils (1), or groups of coils (1), or pairs of coils (1) can be activated singly or in groups; and where the coils (1) can be contained by the core (2) or on the contrary be placed outside the core (2).

7. Electromagnetic propulsion system, according to claim 1, characterized by the use of coils (1) that can be small or long, where one or more opposing pairs of coils (1) can be replaced by a single long coil (1), where the coil(s) (1) can be interconnected by an external core (2), larger or smaller than coil (1), and where each coil (1) can have a core (2) internal to the coil itself of any material, the same or different from an external core (2) if this is used.

8. Electromagnetic propulsion system, according to claim 1, characterized by the use of coils (1) close and arranged parallel to each other, to generate a strong external magnetic field at both ends of the coils (1), organized between itself in any geometric configuration, including a circular or hexagonal configuration with or without cores (2) inside it, or square, ellipsoidal or any other configurations.

9. Electromagnetic propulsion system, according to claim 1, characterized by the use of two or more coils (1) in proximity, with or without internal core (2) and optional support piece (3), arranged to each other at an angle such that it brings one of its ends closer and at the same time moves the opposite end away, where current pulses with asymmetric temporal derivative are applied to one, or two, or more coils (1), with any magnitude or pulse repetition rate, including the application of pulses of extreme magnitude; or by the use of any number of coils (1) in proximity to each other, forming any global geometry and arranged at an angle placing one of their ends closest, such as, for example, non-limiting, the use of three coils (1) in proximity to a horizontal central coil (1) and the other two external coils (1) at an angle less than 90° with the central coil (1); or where the outer coils (1) assume an angle of 90° with the central coil (1); or using any number of coils (1) in lateral proximity and mutual magnetic repulsion, at any angle to each other, along a hemispherical section or half of a sphere, with a two-dimensional “C” or “U” shaped section for example, among other possibilities.

10. Electromagnetic propulsion system, according to claim 1, characterized by the use of various geometric arrangements of any number of coils (1) relative to each other, including configurations of three, four, six or more coils (1), with respective ends in lateral proximity to each other, forming various geometric patterns such as triangular, quadrangular, hexagonal patterns, or any other geometric pattern, depending on the total number of coils (1) used; or because the geometric shapes used for the distributions and geometric organizations of the various coils (1) may simply represent planar two-dimensional sections or geometries with a complex three-dimensional structure, including countless possible variations, where for example, the triangular shape may be planar or three-dimensional pyramidal with the coils (1) arranged along the edges of the 3D pyramid, the quadrangular shape may be planar or a three-dimensional square with six opposite perpendicular open surfaces, with the coils (1) arranged along the edges of this 3D square, the hexagonal shape may be planar or a complex three-dimensional structure, with the coils (1) organized along the edges of geodesic structures of the type created by Buckminster-Fuller similar to the structure, complete, half, or any section, of carbon 60, for example, among many other possibilities and available geometries.

11. Electromagnetic propulsion system according to claim 1, characterized by the use of three, four, five, six or any number of coils (1) arranged symmetrically with each other in a two-dimensional plane, all oriented towards the same geometric center, in a cross for example, in a symmetrical or asymmetrical pattern, with the magnetic field in opposition from all coils (1) to the geometric center, and arranging another coil (1), or more than one coil (1), perpendicular to that plane geometric and in the center of it, placed with its magnetic field in repulsion with the remaining coils (1).

12. Electromagnetic propulsion system, according to claim 1, characterized by the use of linear and symmetrical or conical and asymmetrical coils (1), where the coils (1) and respective cores (2) may assume any geometry and three-dimensional shape with any cross-section, including circular, ellipsoidal, square, triangular or any other cross-section, hollow or solid.

13. Electromagnetic propulsion system, according to claim 1, characterized by the use of coils (1), symmetrical or asymmetrical, with a core (2), of one or more materials, individually uniform or non-uniform, placed or used in a manner that generates a relative magnetic permeability gradient along the core (2), internal or external to the coil (1), or along the interior of the coil (1), in a given direction, where a constant current and magnetic field is applied, or oscillating, or asymmetrically pulsed to one or more coils (1), or one or more propulsion units (5).

14. Electromagnetic propulsion system, according to claim 1, characterized by the use of coils (1) or propulsion units (5), which can be optionally wrapped and protected, individually at one end of the coil (1), or on one or more faces of groups of coils (1), or propulsion units (5), partially and asymmetrically, by any mixture of dielectric, and/or conductive, and/or magnetic material (4); or where the material (4) may eventually completely and symmetrically surround the coil (1) or groups of coils (1) used; or where material (4) may be used around occupants.

15. Electromagnetic propulsion system, according to claim 1, characterized by the use of one or more power sources, of high or low current, or constant current, oscillating, pulsed, or any other, including asymmetric pulses, or with asymmetric current derivative, such as Marx generators, inductive current pulse generators, microwave generators with asymmetric current pulses, among many other options, using any repetition rate of the applied current pulses, and connected to one or more coils (1), in any configuration, including the application of electrical excitation to all coils (1) at the same time, or an isolated excitation on each coil (1), or dual excitation on pairs of coils (1) used, or a simultaneous excitation of geometrically opposite pairs of coils (1), or any other way of applying electrical excitation to the coils (1).

16. Electromagnetic propulsion system according to claim 1, characterized by the use, independently or in conjunction, of any of the propulsion units (5) fixed to a mass (6) or part of that mass (6), which has any shape, and distributed around its periphery, or in any other desired position, inside or outside mass (6), in any number, pattern or arrangement, where we can also make the ship or mass (6) itself a gigantic propulsion unit, using any of the propulsion units (5), where mass (6) may have independent vertical, diagonal or horizontal parts, which may contain propulsion units (5), which may be movable or tiltable in any direction.

17. Force field generation system, according to claim 1, characterized by the use of one or more coils (1), or propulsion units (5), placed on the periphery, surface, or exterior of the mass (6), generating external magnetic fields with asymmetric derivative and large volume, where each coil (1), or groups of coils (1), are connected to one or more power sources.
